(19) United States
(12) Patent Application Publication
(10) Pub. No.: US 2024/0420226 A1
(43) Pub. Date: Dec. 19, 2024

(54) CONTEXTUAL PROGRESS BAR FOR PROGRESSIVE ACTIVATION OF USER INTERACTIONS

(71) Applicant: BBY SOLUTIONS, INC., Richfield, MN (US)

(72) Inventor: Shubin Zhai, Woodbury, MN (US)

(21) Appl. No.: 18/335,659

(22) Filed: Jun. 15, 2023

(51) Int. Cl. G06Q 30/0601; G06F 3/0481; G06F 3/04842; G06F 3/04847; G06F 3/0488; G06T 11/60

(52) U.S. Cl. CPC G06Q 30/0643; G06F 3/0481; G06F 3/04842; G06F 3/04847; G06F 3/0488; G06T 11/60; G06K 7/1413; G06K 7/1417

(57) ABSTRACT

Graphical user interface functionality including a contextual progress bar is disclosed. A user interface (e.g., smartphone app, web browser) in a computing device may be configured to: cause a display of a progress bar that presents a status of an electronic commerce transaction, with the progress bar including an indicator that is movable by a user to control multiple activities that are used to conduct the electronic commerce transaction; receive user interaction to move the indicator from a first position to a second position on the progress bar, to cause at least one activity to be performed in the electronic commerce transaction; and update the display of the progress bar to indicate performance of the activity in the electronic commerce transaction, to display text corresponding to the activity, and to display an amount of progress of the multiple activities of the electronic commerce transaction.

### TECHNICAL FIELD

Embodiments discussed herein generally relate to defined functionality and graphical user interface features used in electronic computing and communication systems. Certain embodiments discussed herein relate to techniques which provide specialized functionality for user interface buttons, and the coordination of related computer-initiated transactions.

### BACKGROUND

A variety of user interface input and navigational controls are used on webpages and software applications (e.g., “apps”) to receive user input, such as buttons, drop-downs, boxes, toggle options, fields, and the like. Some types of input and navigational controls may be unintuitive or difficult to interact with in settings where small screens are used (e.g., on a smartphone), or where multiple inputs must be provided by a user. Such challenges are particularly prevalent in settings involving electronic commerce transactions, where a user may need to provide multiple types of input when attempting to purchase a product, such as separate inputs for selecting an item, selecting a quantity of an item, selecting a payment method for an item, confirming purchase of the item, etc. Accordingly, a variety of user interface design and technical challenges exist to collect user input accurately and efficiently.

### BRIEF DESCRIPTION OF THE DRAWINGS

FIG. 1 illustrates example scenarios for performing an electronic commerce transaction via a user interface, according to an example.

FIG. 2 illustrates an example sequence of functionality provided within a user interface based on use of a contextual progress bar, according to an example.

FIGS. 3A to 3G illustrate sequential uses of a contextual progress bar in a graphical user interface, according to an example.

FIGS. 4A and 4B illustrate additional sequential uses of a contextual progress bar in a graphical user interface, according to an example.

FIG. 5 illustrates a flowchart of an example sequence of display operations for a contextual progress bar in a graphical user interface, according to an example.

FIG. 6 illustrates a flowchart of an example method for implementing a contextual progress bar in a software graphical user interface, according to an example.

FIG. 7 illustrates a block diagram of computing system components implementing user interface functionality for interactions with a contextual progress bar, according to an example.

FIG. 8 illustrates a block diagram of operational components of a computing system upon which any one or more of the techniques herein discussed may be executed and implemented.

### DETAILED DESCRIPTION

The following description and drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The examples discussed herein are directed to features and logic implemented with graphical user interfaces of computing systems, including specific user interface control functionality involving the use of buttons, sliders, status bars, and similar interactive inputs and outputs. An example input and output control includes a configuration of a contextual progress bar that provides an easy-to-use sliding mechanism for a consumer or employee user to control a multi-activity (e.g., sequential) commerce transaction, by performing respective actions when the user slides the indicator of the progress bar from left to right. The contextual progress bar may present a status of the commerce transaction, showing the user whether certain actions or activities have completed, and showing an approximate stage of a multi-stage transaction. The contextual progress bar may present information that is overlaid or placed next to the sliding mechanism, to display real-time information that is relevant to the commerce transaction or the action being performed (or the action to be performed). Thus, in contrast to other types of user input sliders that merely collect input to execute a single transaction (e.g., “Swipe to place your order” or “Slide to complete the transaction”), the contextual progress bar can also present helpful contextual status information and guidance to the user directly on or next to the progress bar.

In some aspects, a contextual progress bar is adapted to display status and enable control of a multi-step workflow or transaction, including during a progression of a shopping and buying journey that involves a shopping cart and a checkout process. The contextual progress bar allows progressive activation of different user interactions, including proceed, pause, and reverse, by moving a dynamic “slider” indicator (e.g., user interface button) that is re-positionable by the user on the contextual progress bar. The movement of the contextual progress bar may initiate or control an electronic commerce workflow that includes specific (e.g., separate or discrete) stages such as add-to-list, add-to-cart, select a payment option, purchase a product, reserve a product, return a product, and the like.

In further aspects, the contextual progress bar may enable specific actions that coordinate with back-end transactions and data processing. For example, requiring user interaction to move a slider indicator from a first position to a second position may have the practical effect of slowing down user requests or transactions, so that a processing server or a transaction engine or database is not overloaded. The contextual progress bar can be used in a variety of settings where multiple actions, activities, or steps are invoked, and may prevent a need to load and present separate buttons and screens. Interaction with the contextual progress bar may initiate a variety of workflows and workflow actions related to selecting, reserving, purchasing, returning, or causing other user-specific actions with a product, service, or related item(s).

As discussed herein, various formats and implementations may be provided for the contextual progress bar, although many of the following examples are provided with reference to a slider and touch gesture-controllable indicator (e.g., button) that is presented on a touchscreen user interface of a tablet, smartphone, or personal computer. However, similar user interface and functionality can be provided within a webpage and browser. Other forms of user interface navigational or selection components may be integrated or used with the contextual progress bar.

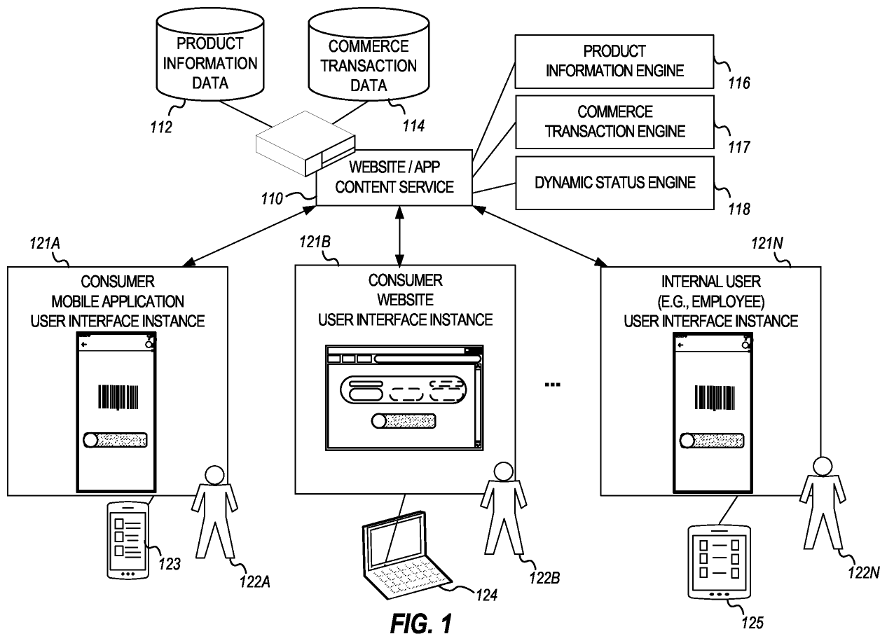

FIG. 1 illustrates an overview of a scenario for performing an electronic commerce transaction via user interfaces 121 that include a contextual progress bar according to the present examples. Here, a contextual progress bar is included in: a consumer mobile application user interface 121A, presented to a consumer 122A via a mobile device 123 (e.g., a smartphone); a consumer website user interface 121B, presented to another consumer 122B via a personal computer device 124; and an internal user (e.g., employee) user interface 121N presented to an employee user 122N via a mobile device 125 (e.g., a tablet). A consumer, as used herein, is not necessarily limited to a personal home user or private customer, but may include a variety of entities representing a person, business entity, organization, etc., A user, as used herein, refers to a broader set of entities such as consumers and employees who interact with the user interface.

In the scenario of FIG. 1, the consumers 122A, 122B respectively access a content service 110 that renders the content of the user interfaces 121A, 121B on a computing device (e.g., smartphone, tablet, personal computer) of the consumer. In an example, the user interface 121A is provided from a website operated in a web browser of the computing device 123, whereas the user interface 121B is provided from a software app operated on the computing device 124 (e.g., a software app distributed via an app store).

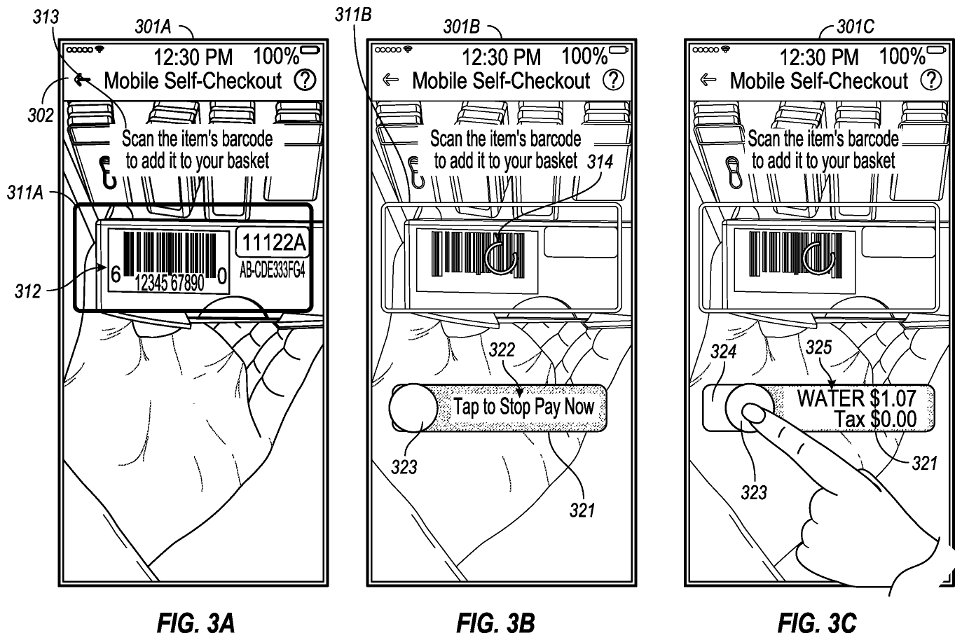

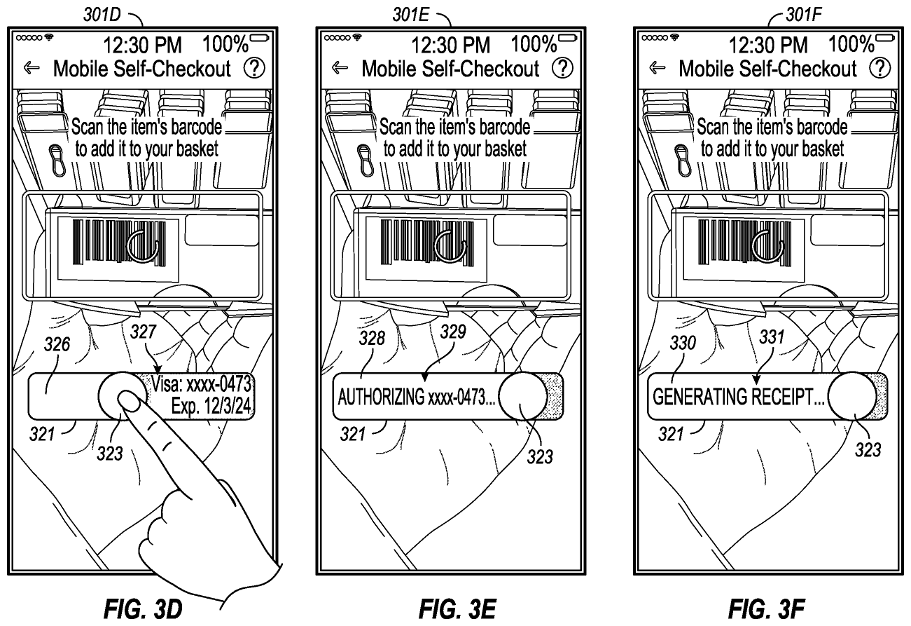

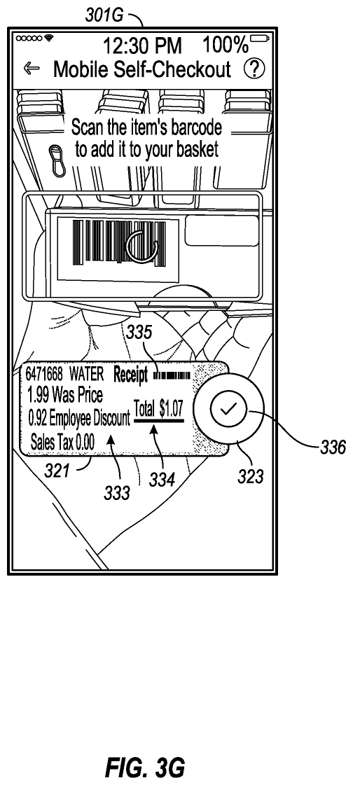

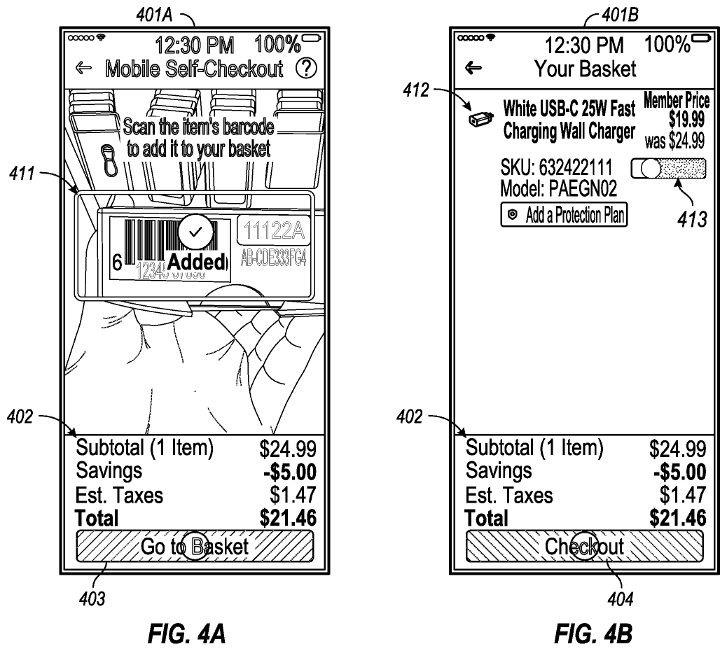

The consumers 122A, 122B operate the user interfaces 121A, 121B to identify, browse, reserve, purchase, schedule, or otherwise interact with aspects of a particular product or service. Example arrangements of portions of consumer user interfaces in an e-commerce setting is provided in FIGS. 3A to 4B and discussed below. Similar functionality may be included in the user interface 121N to perform internal (e.g., employee-only or user-restricted) functions such as inventory checking, employee discounts, price adjustments and discounts, and the like.

The user interfaces 121 may receive content that is hosted or controlled by an internet-accessible content service 110 operated by or on behalf of a business entity such as a retailer. For instance, the content service 110 may operate or integrate with logic provided by a product information engine 116 that retrieves relevant information (e.g., prices, graphics, item descriptions) of a selected commerce item (e.g., product or service), and a commerce transaction engine 117 that operates commerce features and activities (e.g., shopping carts, lists, checkout, payment) for the commerce item. The content service 110 may also operate or integrate with logic of a dynamic status engine 118 that provides different aspects of functionality and information (e.g., based on the availability, price, or options) for the commerce item as well as information for other available (or unavailable) or related commerce items.

The user interfaces 121 may be controlled by the content service 110 to provide pre-programmed or newly-assembled content based on product information data 112 or commerce transaction data 114 obtained from one or more data stores, servers, content delivery network (CDN) caches, and the like. The user interfaces 121 may present this data in the form of text, graphics, video, relating to products, services, or other informational content. The data 112, 114 and related information (e.g., product or service details, user profile information, payment information, etc.) may be cached for use by the user interfaces 121.

The present approaches provide technical implementations in the content service 110, the user interfaces 121, and related data processing engines and databases to support a contextual progress bar with interactive functionality. This contextual progress bar provides clear benefits to accurately control an electronic commerce transaction through the use of an interactive slider feature that allows the transaction to be started, advanced, paused, reversed, and the like. The contextual progress bar can be presented in many locations within the user interface and also coordinated with many existing types of user interface controls such as buttons, links, status messages, dropdowns, or menu options.

One specific implementation of the contextual progress bar includes presentation in a camera display screen, to guide self-checkout actions invoked by a user via a smartphone camera. Here, the contextual progress bar can be overlaid or placed on top of the camera display screen to present real-time information and purchase options for a scanned item. In some examples, scanning a product with a camera may activate a price check or product review/comparison feature, which may be provided in addition to purchase or checkout functionality. In situations where a customer is performing comparison shopping, the progress bar could be used to initiate additional steps in the shopping workflow before final purchase, such as to check for an in-stock status, to chat with an artificial intelligence (AI) bot, to communicate with a virtual agent, or to initiate a voice call with a live agent. In other examples, scanning a product with a camera may automatically select an item for purchase (or, checkout the item), and the contextual progress bar can be used to provide a progressive activation of different user workflow actions such as pause, stop, or reverse. The contextual progress bar can also be presented in other settings involving a camera, augmented reality (AR), or virtual reality (VR) display, allowing a multi-function user interface control to be visible and remain usable on the screen when the camera or augmented/virtual reality view is presented.

In a touchscreen graphical user interface, the user may provide gestures on a dynamic “slider” indicator or button on the contextual progress bar. Accordingly, the contextual progress bar may serve a dual purpose of providing a status of a checkout transaction (e.g., during a checkout/purchase process), in addition to providing user controls that can start, pause, stop, or reverse the transaction. Other described features of the slider user interface control include various responses and actions to respond to behaviors by human users that are commonly performed in a workflow, such as return to shopping cart, reverse a purchase transaction, change a payment method, return an item, and the like.

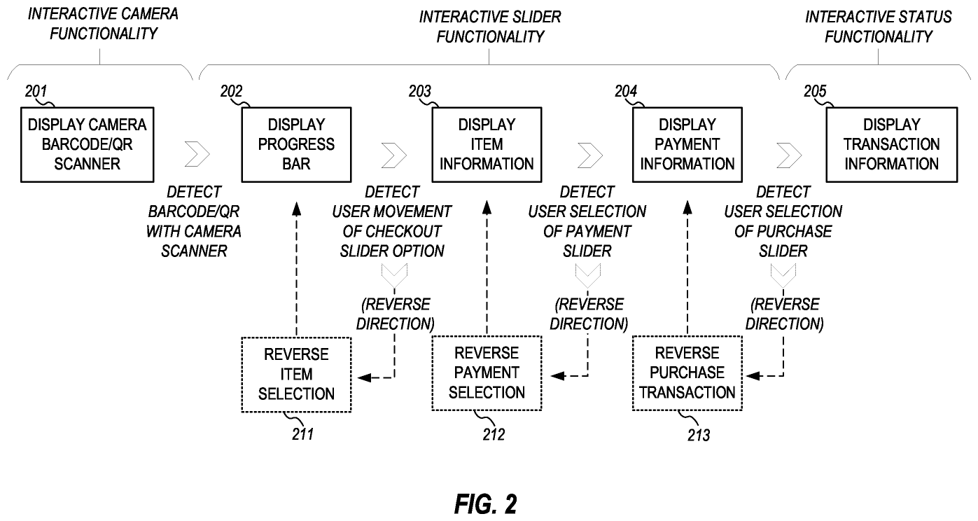

FIG. 2 depicts an example sequence of functionality provided within a user interface based on use of a contextual progress bar. Here, this functionality sequence depicts a scenario for a self-checkout process, where interactive camera functionality (operation 201) enables a scan of an item barcode, QR code, or other unique identifier of the product. In other examples, the interactive camera functionality may perform an image recognition of characteristics or shape of the product packaging or product labeling/branding, such as to directly identify a store-branded single SKU product. This is followed by functionality to output status information and respond to user interaction with a slider indicator (operations 202, 203, 204) on the contextual progress bar. This is followed by functionality (operation 205) to output a transaction status on the contextual progress bar, which allows the status of a completed or canceled commerce transaction to be displayed. Although not depicted, any of the following operations may implement artificial delays that slow down the overall process (e.g., to allow additional time for back-end processing).

The sequence begins at operation 201, with the display of a real-time camera view that provides a barcode or QR scanner. An example of a user interface that provides the camera view for barcode or QR scanning is presented in FIG. 3A, discussed below. When a barcode or QR code of a product is detected via a camera scanner, the product is selected for checkout or purchase. In some examples, a user may select or scan a single product or multiple products (or, services) via a barcode or QR code.

The sequence continues at operation 202, with the display of a contextual progress bar, also referred to as a “status bar”, which provides information and control functionality (e.g., an indicator in the shape of a rounded slider button) to guide a user during the electronic commerce transaction (e.g., a purchase or rental transaction). An example of a user interface that includes an initial display of the contextual progress bar is presented in FIG. 3B, discussed below.

In an example, the indicator on the contextual progress bar may begin movement in response to user interaction, such as a swipe gesture, voice command, or mouse movement (or, a similar user input). In another example, the contextual progress bar may begin movement in response to the prior indication of a purchase intention, reservation, or related action, such as availability of an item for a customer who has reserved the item SKU, and is waiting in a line to receive the item. In another example, the contextual progress bar may begin movement in response to identification of a prior purchase authorization that was provided by the customer, such as when the customer is the next person in line to receive an item, or where the customer is engaging in a bidding or auction for the item. In another example, the indicator on the contextual progress bar may automatically begin movement immediately or after a defined period of time (e.g., n seconds) after scanning or identifying the product. In an automatic scenario, the user may use a swipe gesture or mouse input to stop, pause, or resume the automatic purchase transaction. Other actions that may stop, pause, or resume the automatic purchase transaction may include tapping, tilting, or shaking a mobile device, moving or tilting the user's head or blinking the user's eyes for a user who is wearing a 3D spatial computing device (e.g., AR/VR glasses), and similar gestures or detectable actions.

The sequence of user interface functionality continues at operation 203, with the display of item information (e.g., price, quantity, options, related products and services, etc.). An example of a contextual progress bar that displays item information is presented in FIG. 3C, discussed below. This display of item information may be presented automatically (e.g., after a defined or dynamically calculated period of time) or in response to the user interaction (e.g., the user swipe gesture, shown in FIG. 3C). If the user optionally moves the slider indicator in the reverse (opposite) direction, then the item selection is reversed at operation 211, and the progress bar returns to operation 202.

The sequence of user interface functionality continues at operation 204, with the display of payment information. An example of a contextual progress bar that displays payment information is presented in FIG. 3D, discussed below. The payment information may be presented automatically (e.g., after a defined or dynamically calculated period of time) or in response to the user interaction (e.g., a continuation of the user swipe gesture, shown in FIG. 3D). If the user optionally moves the slider indicator in the reverse (opposite) direction, then the payment selection is reversed at operation 212, and the progress bar returns to operation 203.

The sequence of user interface functionality completes at operation 205, to present an interactive status of transaction information, such as completed purchase details. An example of a contextual progress bar that displays transaction information in the form of a receipt is presented in FIG. 3G. Other types of transaction information status messages or displays may be provided. If the user optionally moves the slider indicator in the reverse (opposite) direction, then the purchase transaction is reversed at operation 213, and the progress bar returns to operation 204.

FIGS. 3A to 3G illustrate sequential uses of a contextual progress bar in a graphical user interface. These illustrations specifically show a step-by-step sequence of how an item may be identified (scanned), selected for payment, and paid for, as part of a purchase commerce transaction. It will be understood that more or fewer steps may be used, and that other commerce actions (e.g., reserve product, identify related accessories or services, check product availability, select a service plan, online ordering, etc.) may be integrated with the sequence. Further, although a horizontal orientation of the contextual progress bar is depicted, the progress bar can be adapted into a vertical orientation. Other directional orientations may be used for 3D space visual displays such as provided by AR/VR headsets.

FIG. 3A illustrates a mobile device graphical user interface 301A, which includes navigational options 302 to select a product for purchase with a “Mobile Self-Checkout” interface. The graphical user interface 301A presents a barcode scanning area 311A which guides a user to position a barcode 312 based on an image or video captured from a real-time camera view of the user's device (e.g., smartphone). Contextual instructions 313 and other status information may be displayed to guide the user to perform the correct action.

FIG. 3B illustrates a progression of mobile device graphical user interface 301B, which presents a status indicator 314 to indicate that a barcode identifier (e.g., universal product code or UPC) has been scanned. After scanning the barcode, the graphical user interface 301B presents a contextual progress bar 321, overlaid on the screen, to present a current status of the purchase transaction. The contextual progress bar 321 includes a status text 322 to communicate this status, and a round indicator 323. The round indicator 323 may be used to control the transaction, but other areas of the contextual progress bar 321 may be used to receive user interaction (e.g., to stop the payment transaction).

FIG. 3C illustrates a further progression of mobile device graphical user interface 301C, which shows the result of user interaction or elapsed time on the status of the progress bar 321. Here, the indicator 323 has moved past area 324 as a result of a user gesture, and the progress bar 321 displays an updated status text 325 relating to product pricing information. The progress bar 321 may use colors, shading, opacity, gradients, or other features to contrast the area 324 from the remainder of the progress bar 321.

FIG. 3D illustrates a further progression of mobile device graphical user interface 301D, which shows the result of additional user interaction or elapsed time on the status of the progress bar 321. Here, the indicator 323 has now moved past area 326 as a result of a user gesture, and the progress bar 321 displays an updated status text 327 relating to payment information. The movement of the indicator 323 past this point will confirm the selection of the payment information (e.g., credit card information) to perform the transaction.

FIG. 3E illustrates a further progression of mobile device graphical user interface 301E, which shows the result of additional user interaction or elapsed time on the status of the progress bar 321 and initial payment processing operations. Here, the indicator 323 has now moved past area 328, and the progress bar 321 displays an updated status text 329 relating to the status of the payment transaction. The movement of the indicator 323 in a reverse direction can be used to reverse or undo the payment transaction (e.g., to initiate a return transaction).

FIG. 3F illustrates a further progression of mobile device graphical user interface 301F, which shows the result of additional user interaction or elapsed time on the status of the progress bar 321 and payment processing operations. Here, the indicator 323 has now moved past area 330, and the progress bar 321 displays an updated status text 331 indicating that the payment transaction has completed, and a receipt will be generated. Again, the movement of the indicator 323 in a reverse direction can be used to reverse or undo the payment transaction.

FIG. 3G illustrates a final progression of mobile device graphical user interface 301G, which shows the result of completing the electronic commerce transaction. The progress bar 321 is used to display receipt information 333 including pricing information 334, a receipt barcode 335, and the like. The indicator may be expanded to provide a completion icon 336 or other status message. Once again, the movement of the indicator 323 in a reverse direction can be used to reverse or undo the payment transaction.

Although the contextual progress bar is depicted in the form of a horizontal slider, it will be understood that other formats may also be used. Likewise, other user interface features such as other status messages (e.g., informational, warning, error messages) may be provided on an adjacent or nearby location of the contextual progress bar (e.g., below, above, or as a pop-up). Other variations may occur in an AR or VR 3D environment, such as a virtual wall that retains the status messages and information when the headset is put on and then disappears after a period of time.

FIGS. 4A and 4B illustrate another example implementation of the contextual progress bar within purchase transaction screens of a graphical user interface such as a mobile computing device software app. FIG. 4A first illustrates a mobile device graphical user interface 401A, which includes navigational options 302 to select a product with a “Mobile Self-Checkout” interface. The interface 401A includes contextual instructions and a barcode scanning area 411 that guide a user to position a barcode within the center of the screen. The interface 401A also includes status information 402 for a scanned item, such as a price of the most recently scanned item or group of items. The status information 402 is accompanied by a user interface control 403 (e.g., button) to navigate to a shopping cart or basket.

FIG. 4B illustrates a progression of mobile device graphical user interface 401B, on a checkout screen for a shopping cart or basket. Here, a contextual progress bar 413 can be presented to perform an electronic commerce transaction for each item (or, group of items) in the shopping cart or basket 412. Other interactive options such as a button 403 to select or add a service (e.g., protection plan) may be presented. Elsewhere in the user interface, the status information 402 is accompanied by another user interface control 404 (e.g., button) to perform a checkout on the shopping cart or basket, such as an alternative to use of the contextual progress bar 413.

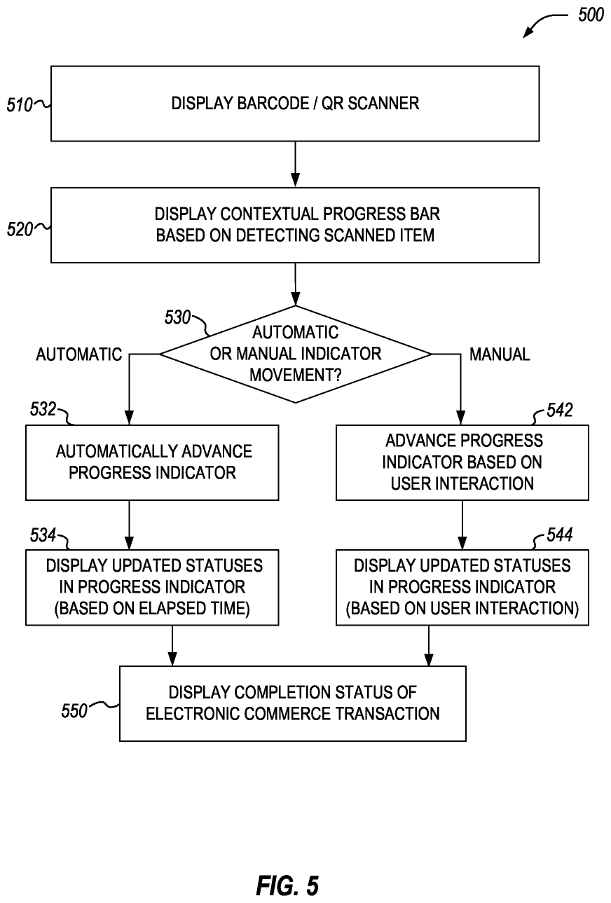

As referenced above, a number of functional aspects or features may be coordinated to render or cause display of various contextual progress bar features. FIG. 5 illustrates a flowchart 500 of an example sequence of display operations for a contextual progress bar, such as implemented by a mobile device app. It will be understood that these operations may not necessarily follow the sequence depicted in flowchart 500, as some operations may be repeated or selectively performed in response to certain events.

The flowchart 500 depicts a first operation 510, to display a barcode or QR scanner (or, to use another camera-based identification process). This scanner display may occur consistent with the examples provided in FIG. 3A, discussed above. The use of the scanner to scan a real-world product item may initiate an electronic commerce transaction such as a price check, product comparison, or purchase of the item.

The flowchart 500 continues by depicting a second operation 520 to display a contextual progress bar based on detecting the scanned item. Here, the contextual progress bar is used to present an ongoing status of an electronic commerce transaction, via contextual information displayed on or adjacent to the progress bar. Consistent with the examples above, the contextual progress bar may include a progress indicator (e.g., button, knob, slider, etc.) that is movable by a user to control multiple activities that are conducted, with such activities being used as part of a workflow to complete (or cancel) the electronic commerce transaction.

The flowchart 500 continues with a determination 530 based on a whether the user interface involves an automatic or manual movement of the indicator, such as movement that is caused or triggered by user interaction to move the indicator from a first position to a second position. If automatic movement of the contextual progress bar is provided, operations 532 and 534 may be performed. At operation 532, the progress indicator may be automatically advanced, as one or more activities are performed in the electronic commerce transaction. At operation 534, one or more updated statuses are displayed in, on, or adjacent to the progress indicator, based on an elapsed time or completed status of the one or more activities. If manual movement of the contextual progress bar is provided, operations 542 and 544 may be performed. At operation 542, the progress indicator is advanced based on user interaction, and one or more activities are performed in the electronic commerce transaction. At operation 544, one or more updated statuses are displayed in, on, or adjacent to the progress indicator based on the user interaction.

The flowchart 500 continues to depict a fifth operation 550, to display a completion status of electronic commerce transaction. This completion status may be displayed on the contextual progress bar consistent with the example provided in FIG. 3G, discussed above.

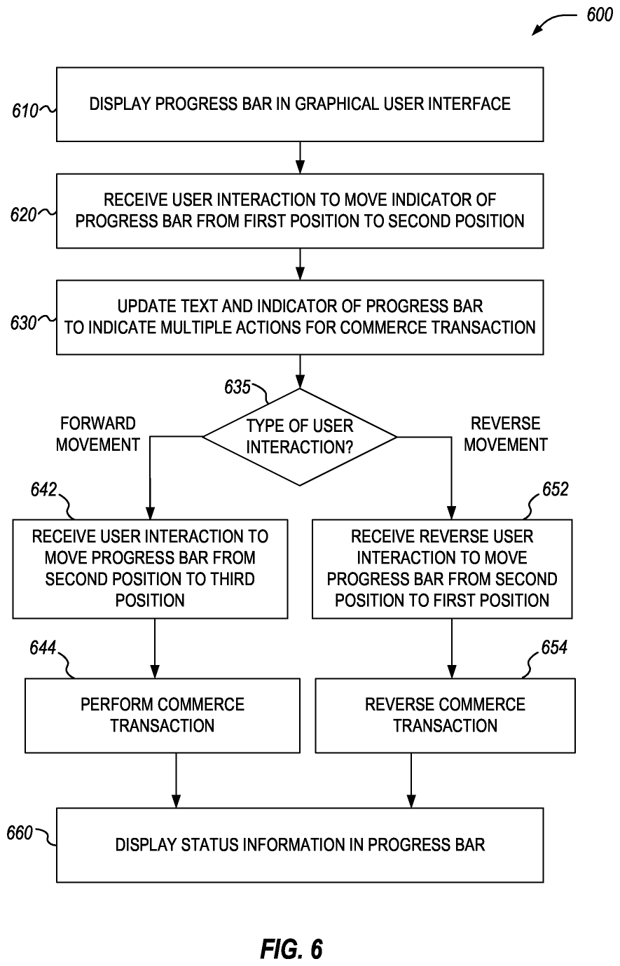

FIG. 6 illustrates a flowchart 600 of an example method for implementing a contextual progress bar in a software graphical user interface, for use with implementations of workflows and operations discussed above. It will be understood that the operations of the flowchart 600 may be implemented in connection with a computer-implemented method, instructions on a computer readable medium, or on a configuration of a computing device or system (or among multiple of such methods, products, or computing devices/systems). In an example, the electronic operations are performed by a computing device that operates to host and generate features of a user-accessible user interface (e.g., from a web server, or for use with a network-connected software app); in another example, the electronic operations are performed within aspects of distributed or client computing devices used to present the user interface.

As shown, the flowchart 600 begins with operation 610 to display a contextual progress bar in a graphical user interface. In a specific example, the contextual progress bar presents a status of an electronic commerce transaction, and the progress bar includes an indicator (e.g., button or tab) that is movable by a user to control multiple activities that conduct the electronic commerce transaction, as discussed above.

In one examples, the graphical user interface includes a real-time camera view from a camera of the computing device, and the display of the progress bar is overlaid on the real-time camera view. Other variations may be provided in a three-dimensional VR or AR display view. Also in a specific example, the display of the progress bar is provided in response to an identification of a barcode, QR code, or product image of a product with the camera, and the electronic commerce transaction causes a price check, comparison, or purchase of the product.

In another example, the graphical user interface includes a checkout screen for a purchase of a product with the electronic commerce transaction, and the display of the progress bar is overlaid on or embedded in the checkout screen.

The flowchart 600 continues at operation 620 to receive a user interaction to move an indicator of the contextual progress bar from a first position to a second position. In a specific example, the user interaction with the indicator occurs in a first direction along an axis, as multiple activities are performed. In specific examples, the user interaction to move the indicator from the first position to the second position on the progress bar causes automatic movement of the indicator on the progress bar and causes automatic performance of the multiple activities in the electronic commerce transaction, and the display of the progress bar is updated to show each of the multiple activities for the electronic commerce transaction. Further, the progress bar may be configured to receive a subsequent user interaction that stops the automatic movement of the indicator on the progress bar and stops (or pauses) the automatic performance of the multiple activities in the electronic commerce transaction.

The flowchart 600 continues at operation 630 to update the status text and the indicator of the progress bar to indicate multiple activities (e.g., actions) for the commerce transaction. In an example, the multiple activities are part of a purchase workflow for the electronic commerce transaction, and the purchase workflow includes: a first stage to display contextual instructions to the user regarding a purchase of a product; a second stage to display item information to the user regarding the purchase of the product; a third stage to display payment information to the user regarding the purchase of the product; and a fourth stage to display transaction information to the user regarding the purchase of the product based on processing of the payment information. Other stages or workflows may be used.

The flowchart 600 continues with a determination 635 dependent on whether the user interface receives a forward movement user interaction, or a reverse movement user interaction.

If forward movement of the contextual progress bar is provided, operations 642 and 644 are performed. At operation 642, the user interface may receive a second user interaction to move the indicator from the second position to a third position on the progress bar, as the second user interaction moves the indicator in the first direction along the axis. Here, the second user interaction causes a subsequent activity to be performed in the electronic commerce transaction, at operation 644.

If reverse movement of the contextual progress bar is provided, operations 652 and 654 may be performed. At operation 652, the user interface may receive a reverse user interaction to move the indicator from the second position to the first position on the progress bar, as the reverse user interaction moves the indicator in a second direction along the axis that is opposite of the first direction. Here, the reverse user interaction causes the activity to be reversed (e.g., to directly undo the activity, or to perform an appropriate activity that can reverse the effects of the activity) in the electronic commerce transaction, at operation 654.

The flowchart 600 continues to depict a final operation 660, to display status information in the progress bar. The status information may be provided based on the specific activities, workflows, or outcomes of the electronic commerce transaction. In specific examples, the electronic commerce transaction relates to at least one data processing activity that is initiated for an in-store pickup, a back-end order fulfillment, or a supply chain status. Also in specific examples, a speed of updating the display of the progress bar is based on a type or status of at least one data processing activity.

As will be understood, other variations in the speed or manner of display of status information may be provided. Thus, the contextual progress bar may be used to identify or trigger a store pickup, backend order fulfillment or supply chain related status while being limited to data values or conditions such as availability constraints, high order volumes, or load of back-end servers. In still further examples, a user's progress bar speed is adjusted based on the type and number of steps per context, and additional statuses or actions (e.g., additional user UI popups and exits) enable a user interface to intelligently adjust. In this manner, the user interface may adapt to back-end system capability constraints without negatively impacting the user experience, by intentionally delaying the display of information or slowing the speed of the actions via the contextual progress bar.

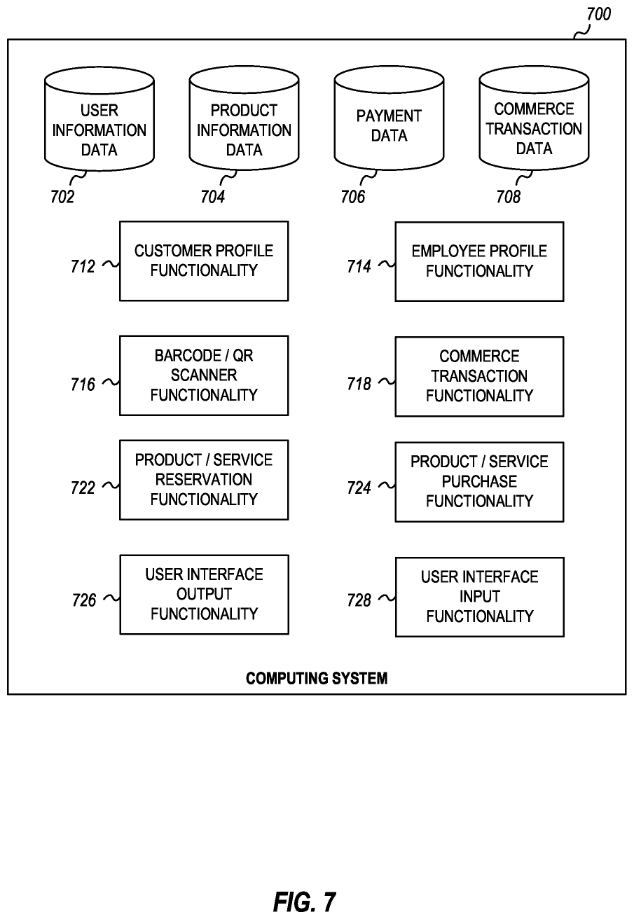

Other combinations and subsystems may be implemented to coordinate with the operations of flowchart 600, such as illustrated with the following components in FIG. 7. Although many of the preceding and following operations are described with reference to the client-side user interface functions, it will be understood that corresponding operations may be programmatically established or controlled at a server or third-party computer by a hosted website, compiled software package, for implementation of the contextual progress bar within various forms of a browser or software app.

FIG. 7 illustrates a block diagram of hardware and functional components of a computing system 700 to implement and support user interface functionality involving a contextual progress bar, such as are accomplished with the examples described above. It will be understood, that although certain hardware and functional components are depicted in FIG. 7 and in other drawings as separate subsystems or services, the features of the subsystems or services may be integrated into a single system or service (e.g., in an application programming interface hosted by a server computing system, or in a software package executable by a mobile computing device). Further, although only one computing system is depicted, it will be understood that the features of these systems may be distributed among one or multiple computing systems (including in cloud-based processing settings).

As shown, the computing system 700 includes various functionality subsystems 712-728 used to implement functionality of the dynamic user interface control for selection of a constrained item (e.g., to implement the techniques discussed above for FIGS. 1-2, 3A-3G, 4A-4B, and 5-6) and data stores 702-708 (e.g., databases) to store and provide information that facilitates a selection, interaction, reservation, or purchase of a product or service as part of an electronic commerce transaction. In an example, the computing system 700 is adapted to execute respective software applications that implement the functionality subsystems and databases through multiple processing components and functionality, such as via circuitry and software instructions.

In an example, the computing system 700 is adapted to implement respective functionality including: customer profile functionality 712 (e.g., circuitry or software instructions) used to display, update, or provide customized information (e.g., pricing, availability) based on a profile associated with the customer user; employee profile functionality 714 (e.g., circuitry or software instructions) used to display, update, or provide customized information (e.g., internal pricing, expanded availability or inventory) based on a permission or access control associated with a particular employee role; barcode/QR scanner processing or functionality 716 (e.g., circuitry or software instructions) used to obtain a product identifier (e.g., UPC code, SKU, etc.) using a camera image of a real-world object; commerce transaction processing or functionality 718 (e.g., circuitry or software instructions) used to activate or otherwise control actions associated with an electronic commerce transaction (such as a reservation, rental, or purchase of a product or service); product/service reservation processing or functionality 722 (e.g., circuitry or software instructions) used to identify or reserve inventory or scheduling associated with some product or service; product/service purchase processing or functionality 724 (e.g., circuitry or software instructions) used to identify or perform a purchase, rental, or funding transaction associated with a product or service; user interface output processing or functionality 726 (e.g., circuitry or software instructions) used to provide output features and arrangements of a user interface that includes a contextual progress bar and related status information displays; user interface input processing or functionality 728 (e.g., circuitry or software instructions) used to identify and respond to input in the user interface (e.g., user gestures) that includes the contextual progress bar. Other functional and processing aspects may be performed or structurally embodied by the computing system 700 (or coordinated computing systems or devices) to implement the techniques discussed above for FIGS. 1-2, 3A-3G, 4A-4B, and 5-6.

Embodiments used to facilitate and perform the techniques described herein may be implemented in one or a combination of hardware, firmware, or software. Embodiments may also be implemented as instructions stored on a machine-readable storage medium (e.g., a storage device), which may be read and executed by at least one processor to perform the operations described herein. A machine-readable storage medium may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

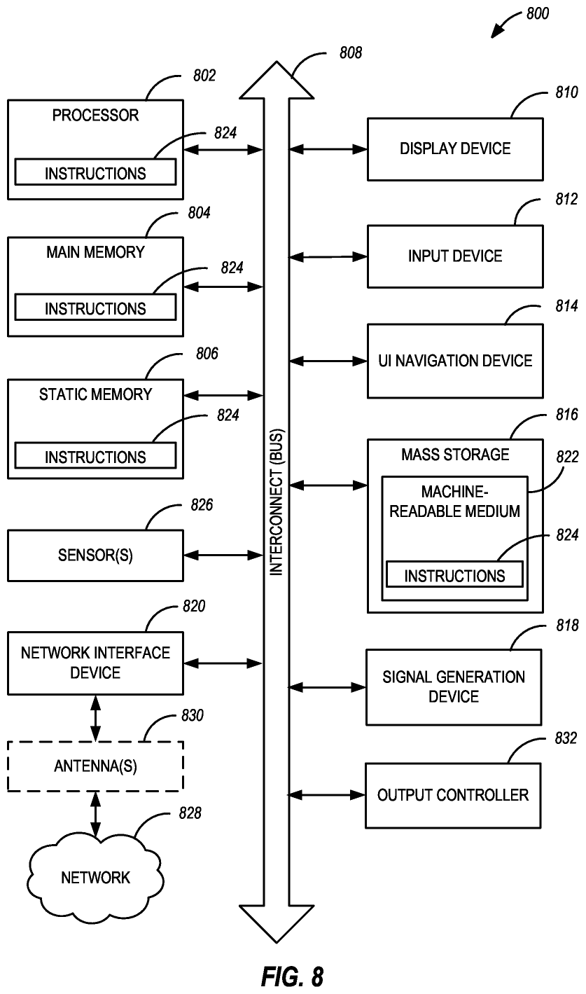

FIG. 8 illustrates a block diagram illustrating a machine in the example form of a computer system machine 800, within which a set or sequence of instructions may be executed to cause the machine to perform any one of the methodologies discussed herein, according to an example. Computer system machine 800 may be embodied by the computing system 700; the subsystem(s) implementing the data stores 702, 704, 706, 708; the subsystem(s) implementing the various modules or functionality 712, 714, 716, 718, 722, 724, 726, 728; the services 110, engines 116, 117, 118 and data stores for data 112, 114; the computing devices 123, 124, 125; or any other electronic processing or computing platform described or referred to herein. Further, the computer system machine 800 may embody instructions and data to perform any of the interfaces or functions referenced for FIGS. 1-2, 3A-3G, 4A-4B, and 5-7. Example computer system machine 800 includes at least one

processor 802 (e.g., a central processing unit (CPU), a graphics processing unit (GPU) or both, processor cores, compute nodes, etc.), a main memory 804 and a static memory 806, which communicate with each other via an interconnect 808 (e.g., a link, a bus, etc.). The computer system machine 800 may further include a video display unit 810, an alphanumeric input device 812 (e.g., a keyboard), and a user interface (UI) navigation device 814 (e.g., a mouse). In one example, the video display unit 810, input device 812 and UI navigation device 814 are incorporated into a touchscreen interface and touchscreen display. The computer system machine 800 may additionally include a storage device 816 (e.g., a drive unit), a signal generation device 818 (e.g., a speaker), an output controller 832, a network interface device 820 (which may include or operably communicate with one or more antennas 830, transceivers, or other wireless communications hardware), and one or more sensors 826, such as a global positioning system (GPS) sensor, compass, accelerometer, location sensor, or other sensor.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system machine 800, with the main memory 804, static memory 806, and the processor 802 also constituting machine-readable media.

While the machine-readable medium 822 is illustrated in an example to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 828 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 2G/3G, 4G LTE/LTE-A, 5G, or Satellite communication networks). The term “transmission medium” shall be taken to include any intangible medium that is capable of storing, encoding, or carrying instructions for execution by the machine, and includes digital or analog communications signals or other intangible medium to facilitate communication of such software.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Additional examples of the presently described method, system, and device embodiments include the following configurations recited by the claims. Each of the examples in the claims may stand on its own, or may be combined in any permutation or combination with any one or more of the other examples provided below or throughout the present disclosure.

What is claimed is:

1. A method for implementing a contextual progress bar in a graphical user interface, the method comprising operations executed using processor circuitry of a computing device, and the operations comprising:
causing a display of a progress bar that presents a status of an electronic commerce transaction, the progress bar including an indicator that is movable by a user to control multiple activities used to conduct the electronic commerce transaction;
receiving user interaction to move the indicator from a first position to a second position on the progress bar, wherein the user interaction causes an activity to be performed in the electronic commerce transaction; and
updating the display of the progress bar to indicate performance of the activity in the electronic commerce transaction, wherein the progress bar is updated to display text corresponding to the activity, and wherein the progress bar is updated to display an amount of progress of the multiple activities of the electronic commerce transaction.

2. The method of claim 1, wherein the user interaction of the indicator occurs in a first direction along an axis.

3. The method of claim 2, the operations further comprising:
receiving a second user interaction to move the indicator from the second position to a third position on the progress bar, wherein the second user interaction moves the indicator in the first direction along the axis, and wherein the second user interaction causes a subsequent activity to be performed in the electronic commerce transaction.

4. The method of claim 2, the operations further comprising:
receiving a reverse user interaction to move the indicator from the second position to the first position on the progress bar, wherein the reverse user interaction moves the indicator in a second direction along the axis that is opposite of the first direction, and wherein the reverse user interaction causes the activity to be reversed in the electronic commerce transaction.

5. The method of claim 1, wherein the graphical user interface includes a real-time camera view from a camera of the computing device, and wherein the display of the progress bar is overlaid on the real-time camera view.

6. The method of claim 5, wherein the display of the progress bar is provided in response to an identification of a barcode, QR code, or product image of a product with the camera, and wherein the electronic commerce transaction causes a price check, comparison, or purchase of the product.

7. The method of claim 1, wherein the graphical user interface includes a checkout screen for a purchase of a product with the electronic commerce transaction, and wherein the display of the progress bar is overlaid on the checkout screen.

8. The method of claim 1, wherein the multiple activities are part of a purchase workflow for the electronic commerce transaction, wherein the purchase workflow includes:
a first stage to display contextual instructions to the user regarding a purchase of a product;
a second stage to display item information to the user regarding the purchase of the product;
a third stage to display payment information to the user regarding the purchase of the product; and
a fourth stage to display transaction information to the user regarding the purchase of the product based on processing of the payment information.

9. The method of claim 1, wherein the user interaction to move the indicator from the first position to the second position on the progress bar causes automatic movement of the indicator on the progress bar and causes automatic performance of the multiple activities in the electronic commerce transaction,
wherein the display of the progress bar is updated to show each of the multiple activities for the electronic commerce transaction, and
wherein the progress bar is configured to receive a subsequent user interaction that stops the automatic movement of the indicator on the progress bar and stops the automatic performance of the multiple activities in the electronic commerce transaction.

10. The method of claim 1, wherein the electronic commerce transaction relates to at least one data processing activity that is initiated for an in-store pickup, a back-end order fulfillment, or a supply chain status, and wherein a speed of updating the display of the progress bar is based on the at least one data processing activity.

11. A non-transitory computer-readable storage medium, the computer-readable storage medium comprising instructions that, when executed by processor circuitry and memory of a computing device, causes the computing device to perform operations that:
display of a progress bar that presents a status of an electronic commerce transaction, the progress bar including an indicator that is movable by a user to control multiple activities used to conduct the electronic commerce transaction;
detect user interaction to move the indicator from a first position to a second position on the progress bar, wherein the user interaction causes an activity to be performed in the electronic commerce transaction; and
update the display of the progress bar to indicate performance of the activity in the electronic commerce transaction, wherein the progress bar is updated to display text corresponding to the activity, and wherein the progress bar is updated to display an amount of progress of the multiple activities of the electronic commerce transaction.

12. The computer-readable storage medium of claim 11, wherein the user interaction of the indicator occurs in a first direction along an axis.

13. The computer-readable storage medium of claim 12, the instructions further to cause the computing device to perform operations that:
receive a second user interaction to move the indicator from the second position to a third position on the progress bar, wherein the second user interaction moves the indicator in the first direction along the axis, and wherein the second user interaction causes a subsequent activity to be performed in the electronic commerce transaction.

14. The computer-readable storage medium of claim 12, the instructions further to cause the computing device to perform operations that:
receive a reverse user interaction to move the indicator from the second position to the first position on the progress bar, wherein the reverse user interaction moves the indicator in a second direction along the axis that is opposite of the first direction, and wherein the reverse user interaction causes the activity to be reversed in the electronic commerce transaction.

15. The computer-readable storage medium of claim 11, wherein the progress bar is displayed as an overlay of a real-time camera view from a camera of the computing device, and wherein the display of the progress bar is provided in response to an identification of a barcode, QR code, or product image of a product with the camera.

16. The computer-readable storage medium of claim 11, wherein the display of the progress bar is presented on a checkout screen used for a purchase of a product with the electronic commerce transaction.

17. The computer-readable storage medium of claim 11, wherein the multiple activities are part of a purchase workflow for the electronic commerce transaction, wherein the purchase workflow includes:
a first stage to display contextual instructions to the user regarding a purchase of a product;
a second stage to display item information to the user regarding the purchase of the product;
a third stage to display payment information to the user regarding the purchase of the product; and
a fourth stage to display transaction information to the user regarding the purchase of the product based on processing of the payment information.

18. The computer-readable storage medium of claim 11, wherein the user interaction to move the indicator from the first position to the second position on the progress bar causes automatic movement of the indicator on the progress bar and causes automatic performance of the multiple activities in the electronic commerce transaction,
wherein the display of the progress bar is updated to show each of the multiple activities for the electronic commerce transaction, and
wherein the progress bar is configured to receive a subsequent user interaction that stops the automatic movement of the indicator on the progress bar and stops the automatic performance of the multiple activities in the electronic commerce transaction.

19. A computing device comprising:
a touchscreen to display a graphical user interface and to receive user interaction;
at least one processor; and
memory coupled to the at least one processor and storing instructions that, when executed by the at least one processor, cause the computing device to perform operations that:
output a progress bar in the graphical user interface that presents a status of an electronic commerce transaction, the progress bar including an indicator that is movable by a user to control multiple activities used to conduct the electronic commerce transaction;
move the indicator from a first position to a second position on the progress bar, based on the user interaction, to cause an activity to be performed in the electronic commerce transaction; and
output an updated display of the progress bar to indicate performance of the activity in the electronic commerce transaction, wherein the progress bar is updated to display text corresponding to the activity, and wherein the progress bar is updated to display an amount of progress of the multiple activities of the electronic commerce transaction.

20. The computing device of claim 19, wherein the user interaction of the indicator occurs in a first direction along an axis; and
wherein the instructions further cause the computing device to perform operations that:
move the indicator from the second position to a third position on the progress bar, in the first direction along the axis, to cause a subsequent activity to be performed in the electronic commerce transaction; or
move the indicator from the second position to the first position on the progress bar, in a second direction along the axis that is opposite of the first direction, to cause the activity to be reversed in the electronic commerce transaction.

21. The computing device of claim 19, wherein the multiple activities are part of a purchase workflow for the electronic commerce transaction, wherein the purchase workflow includes:
a first stage to display contextual instructions to the user regarding a purchase of a product;
a second stage to display item information to the user regarding the purchase of the product;
a third stage to display payment information to the user regarding the purchase of the product; and
a fourth stage to display transaction information to the user regarding the purchase of the product based on processing of the payment information.
